(19) United States
(12) Patent Application Publication
(10) Pub. No.: US 2026/0200132 A1
(43) Pub. Date: Jul. 16, 2026

(54) CONTINUOUS CEMENTITIOUS BOARD MANUFACTURING WITH IN SITU FOAM GENERATION

(71) Applicant: UNITED STATES GYPSUM COMPANY, Chicago, IL (US)

(72) Inventors: Annamaria VILINSKA, Chicago, IL (US); Mark Kenneth HEMPHILL, Hawthorn Woods, IL (US); Stergios KARAKOUSSIS, Iphofen (DE)

(73) Assignee: UNITED STATES GYPSUM COMPANY, Chicago, IL (US)

(21) Appl. No.: 19/412,634

(22) Filed: Dec. 8, 2025

Related U.S. Application Data
(60) Provisional application No. 63/745,668, filed on Jan. 15, 2025.

(51) Int. Cl. B28B 19/00; B28B 1/50; C04B 11/28; C04B 28/14

(52) U.S. Cl. CPC B28B 19/0092; B28B 1/50; C04B 11/28; C04B 28/141

(57) ABSTRACT

An in situ foam generator is part of a system for manufacturing cementitious board. The foam generator is configured to generate foam in situ in a discharge conduit downstream of a mixer in which water and a cementitious material are agitated to form an aqueous cementitious slurry.

### CROSS-REFERENCE TO RELATED APPLICATION

This patent application claims the benefit of priority to U.S. Provisional Patent Application No. 63/745,668, filed January 15, 2025, and entitled, “Continuous Cementitious Board Manufacturing with In Situ Foam Generation,” which is incorporated in its entirety herein by this reference.

### BACKGROUND

The present disclosure relates to continuous cementitious board manufacturing processes and, more particularly, to a system and method for making cementitious board in a continuous manner with an in situ foam generation system on a board line.

In many types of cementitious articles, set gypsum (calcium sulfate dihydrate) is often a major constituent. For example, set gypsum is a major component of end products created by use of traditional plasters (e.g., plaster-surfaced internal building walls), and also in faced gypsum board employed in typical drywall construction of interior walls and ceilings of buildings. In addition, set gypsum is the major component of gypsum/cellulose fiber composite boards and products, as described in U.S. Patent No. 5,320,677, for example. Also, many specialty materials, such as materials useful for modeling and mold-making, produce products that contain major amounts of set gypsum. Typically, such gypsum-containing cementitious products are made by preparing a mixture of calcined gypsum (calcium sulfate alpha or beta hemihydrate and/or calcium sulfate anhydrite), water, and other components, as appropriate to form cementitious slurry. In the manufacture of cementitious articles, the cementitious slurry and desired additives are often blended in a continuous mixer, as described in U.S. Patent No. 3,359,146, for example.

In a typical cementitious board manufacturing process such as wallboard, gypsum board is produced by uniformly dispersing calcined gypsum (commonly referred to as “stucco”) in water to form aqueous calcined gypsum slurry. The aqueous calcined gypsum slurry is typically produced in a continuous manner by inserting stucco and water and other additives into a mixer which contains means for agitating the contents to form a uniform gypsum slurry. The slurry is continuously directed toward and through a discharge outlet of the mixer and into a discharge conduit connected to the discharge outlet of the mixer.

Air is typically added to gypsum slurries to reduce the density of gypsum-based building materials. For example, pre-generated aqueous foam is added to a gypsum slurry which is then used to form gypsum wallboard. The pre-generated foam is typically added into the mixer and/or the discharge conduit downstream of the mixer discharge outlet. When the foam is added into the mixer, a significant portion of the air is lost as the foam bubbles are broken, and the density control can be challenging. Density control can be improved by adding the foam in the discharge conduit, but the water present in the foam typically adds to the overall water demand of the gypsum slurry and excess water will need to be dried out of the board.

A stream of foamed slurry passes through the discharge conduit from which it is continuously deposited onto a moving web of cover sheet material supported by a forming table. The foamed slurry is allowed to spread over the advancing web. A second web of cover sheet material is applied to cover the foamed slurry and form a sandwich structure of a continuous wallboard preform, which is subjected to forming, such as at a conventional forming station, to obtain a desired thickness.

With the core of the board being made from increasingly less dense gypsum slurry, it can be desirable to position a more dense and/or stronger slurry against one or more of the cover sheet faces (commonly referred to as a “skim coat”) and/or at the lateral edges of the board. The skim coat can help enhance the bond between the cover sheet material and the dried cementitious material. The edge material can help allow for the handling of the board without excessive damage to its edges and also to allow for the secure attachment of the board to a framing structure via fasteners located at the edges of the board.

The calcined gypsum reacts with the water in the wallboard preform and sets as a conveyor moves the wallboard preform down a manufacturing line. The wallboard preform is cut into segments at a point along the line where the preform has set sufficiently. The segments are flipped over, dried in a dryer to drive off excess water, and processed to provide the final wallboard product of desired dimensions. The aqueous foam produces air voids in the set gypsum, thereby reducing the density of the finished product relative to a product made using a similar slurry but without foam.

Prior devices and methods for addressing some of the operational problems associated with the production of gypsum wallboard are disclosed in commonly-assigned U.S. Patent Nos. 5,683,635; 5,643,510; 6,494,609; 6,874,930; 7,007,914; and 7,296,919, which are incorporated by reference. There is a continued need in the art to provide additional solutions to enhance the production of cementitious boards. For example, there is a continued need for techniques for mitigating the amount of excess water introduced into the cementitious slurry which is removed in a drying process using energy to produce a dry cementitious board.

It will be appreciated that this background description has been created to aid the reader and is not to be taken as an indication that any of the indicated problems were themselves appreciated in the art. While the described principles can, in some aspects and embodiments, alleviate the problems inherent in other systems, it will be appreciated that the scope of the protected innovation is defined by the attached claims and not by the ability of any disclosed feature to solve any specific problem noted herein.

### SUMMARY

In one aspect, the present disclosure is directed to embodiments of a system for manufacturing a cementitious board. In embodiments, a system for manufacturing a cementitious board includes an in situ foam generation system downstream of a mixer adapted to mix a cementitious material and water together to form a cementitious slurry.

In one embodiment, a system for manufacturing a cementitious board includes a mixer, a discharge conduit, and a foam generation system. The mixer includes a housing and an agitator disposed within the housing. The housing has an outlet. The agitator is configured to agitate water and cementitious material to form an aqueous cementitious slurry. The discharge conduit is in fluid communication with the outlet of the mixer. The discharge conduit includes a mixer portion and a terminal portion. The mixer portion is connected to the outlet of the mixer. The terminal portion is downstream of the mixer portion relative to a flow direction of aqueous cementitious slurry from the mixer through the discharge conduit.

The foam generation system includes a foam generation mixer, a supply of foaming agent, and a supply of air. The foam generation mixer comprises a foam portion of the discharge conduit disposed between the mixer portion and the terminal portion. The supply of foaming agent is in fluid communication with the mixer portion of discharge conduit at a soap junction between the outlet of the mixer and the foam generation mixer. The supply of air is in fluid communication with the foam generation mixer.

In another aspect of the present disclosure, embodiments of an in situ foam generator for a system for manufacturing cementitious board are described. In embodiments, an in situ foam generation system is configured to generate foam in situ in a discharge conduit of a mixer and blend the foam with a cementitious slurry downstream of the mixer.

In another aspect of the present disclosure, embodiments of a method of making a cementitious board are described. In one embodiment of a method of making a cementitious board, the method includes agitating ingredients of at least water and a cementitious material in a mixer to form a flow of aqueous cementitious slurry. The flow of aqueous cementitious slurry is discharged from the mixer into a discharge conduit. A supply of foaming agent is introduced into the discharge conduit at a soap junction to disperse the supply of foaming agent into the flow of aqueous cementitious slurry. At a point downstream of the soap junction relative to a flow direction of the flow of aqueous cementitious slurry from the mixer, the flow of aqueous cementitious slurry is mixed with a supply of air to produce a flow of foamed cementitious slurry. The flow of foamed cementitious slurry is discharged from the discharge conduit onto a web of cover sheet material moving along a machine direction.

Further and alternative aspects and features of the disclosed principles will be appreciated from the following detailed description and the accompanying drawings. As will be appreciated, the in situ foam generators, systems for manufacturing a cementitious board, and techniques for making a cementitious board disclosed herein are capable of being carried out and used in other and different embodiments, and capable of being modified in various respects. Accordingly, it is to be understood that both the foregoing general description and the following detailed description are exemplary and explanatory only and do not restrict the scope of the appended claims.

### BRIEF DESCRIPTION OF THE DRAWINGS

FIG. 1 is a schematic elevational diagram of an embodiment of a system for manufacturing a cementitious board constructed in accordance with principles of the present disclosure, including an embodiment of an in situ foam generation system constructed in accordance with principles of the present disclosure.

FIG. 2 is an enlarged detail view taken from FIG. 1 of the in situ foam generation system.

It should be understood that the drawings are not necessarily to scale and that the disclosed embodiments are sometimes illustrated diagrammatically and in partial views. In certain instances, details which are not necessary for an understanding of this disclosure or which render other details difficult to perceive may have been omitted. It should be understood that this disclosure is not limited to the particular embodiments illustrated herein.

### DETAILED DESCRIPTION OF EXEMPLARY EMBODIMENTS

The present disclosure provides various embodiments of an in situ foam generation system that can be used in the manufacture of cementitious products, including cementitious boards such as gypsum wallboard, for example. Embodiments of an in situ foam generation system constructed in accordance with principles of the present disclosure can be used in a manufacturing process to effectively introduce air voids into a cementitious slurry while mitigating the introduction of excess water that would otherwise have to be removed in a drying process using thermal energy. Embodiments of an in situ foam generation system constructed in accordance with principles of the present disclosure can be arranged with the discharge conduit of a mixer at a wet end of cementitious board manufacturing line to introduce air voids into the cementitious slurry formed in the mixer.

Embodiments of systems for manufacturing a cementitious product following principles of the present disclosure can include means for generating, in situ, foam downstream of a mixer adapted to mix a cementitious material and water together to form a cementitious slurry. Embodiments of methods for continuously manufacturing a cementitious product following principles of the present disclosure can include a step for generating, in situ, foam downstream of a mixer adapted to mix a cementitious material and water together to form a cementitious slurry. In embodiments, the means and step for generating, in situ, foam downstream of a mixer adapted to mix a cementitious material and water together to form a cementitious slurry can comprise a foam generation system constructed according to principles of the present disclosure.

In embodiments following principles of the present disclosure, a foam generation system is adapted to introduce air voids into a cementitious slurry using a high shear mixer, a supply of foaming agent, and a controlled flow of air. The foaming agent is introduced into the cementitious slurry in a discharge conduit and blended with air under high shear conditions in a high shear mixer to entrain air into the slurry. Rather than using water or any other liquid as to produce a pre-formed aqueous foam, the foaming agent forms bubbles in situ in the slurry. The resulting foamed slurry contains only the water introduced into the main mixer and does not have extra water added to it via an aqueous foam.

The present disclosure provides various embodiments of an in situ foam generation system that can be used in the manufacture of different types of cementitious boards as will be appreciated by one skilled in the art. In embodiments, a system for manufacturing a cementitious board constructed according to principles of the present disclosure can be used to make a cementitious board, such as, a gypsum wallboard, an acoustical panel, or a portland cement board, for example.

In embodiments following principles of the present disclosure, the cementitious slurry can be any conventional cementitious slurry, for example any cementitious slurry suitable to produce gypsum wallboard as will be appreciated by one skilled in the art; acoustical panels including, for example, acoustical panels described in U.S. Patent Application Publication No. 2004/0231916; or portland cement board, for example. As such, the cementitious slurry can further comprise any additive that is commonly used in the production of cementitious products. Such additives include structural additives, including mineral wool, continuous or chopped glass fibers (also referred to as fiberglass), perlite, clay, vermiculite, calcium carbonate, polyester, and paper fiber, and chemical additives, including foaming agents, fillers, accelerators, sugar, enhancing agents (such as phosphates, phosphonates, borates and the like), retarders, binders (such as starch and latex), colorants, fungicides, biocides, hydrophobic agent (such as a silicone-based material, including a silane, siloxane, or silicone-resin matrix, e.g.), and the like. Examples of the use of some of these and other additives are described, for instance, in U.S. Patent Nos. 6,342,284; 6,632,550; 6,800,131; 5,643,510; 5,714,001; and 6,774,146; and U.S. Patent Application Publication Nos. 2002/0045074; 2004/0231916; 2005/0019618; 2006/0035112; and 2007/0022913.

Non-limiting examples of cementitious materials include portland cement, sorrel cement, slag cement, fly ash cement, calcium alumina cement, water-soluble calcium sulfate anhydrite, calcium sulfate α-hemihydrate, calcium sulfate β-hemihydrate, natural, synthetic or chemically-modified calcium sulfate hemihydrate, calcium sulfate dihydrate (“gypsum,” “set gypsum,” or “hydrated gypsum”), and mixtures thereof. In one aspect, the cementitious material desirably comprises calcined gypsum (sometimes referred to as, “stucco”), such as in the form of calcium sulfate alpha hemihydrate, calcium sulfate beta hemihydrate, and/or calcium sulfate anhydrite. The calcined gypsum can be fibrous in some embodiments and nonfibrous in other embodiments. In embodiments, the calcined gypsum can include at least 50% beta calcium sulfate hemihydrate. In other embodiments, the calcined gypsum can include at least 86% beta calcium sulfate hemihydrate.

The weight ratio of water to calcined gypsum in a cementitious slurry suitable for use in embodiments following principles of the present disclosure can be any suitable ratio, although, as one of ordinary skill in the art will appreciate, lower ratios can be more efficient because less excess water will remain after the hydration process of the stucco is completed to be driven off during manufacture, thereby conserving energy. In some embodiments, the cementitious slurry can be prepared by combining water and calcined gypsum in a suitable water to stucco weight ratio for board production depending on products, such as in a range between 1:6 and 1:1, e.g., 2:3.

In embodiments of systems and methods according to principles of the present disclosure, the cementitious board manufactured can be in the form of gypsum wallboard. As used herein, the term wallboard is not limited to the use of the board on walls, but can also include boards used for ceilings, partitions, etc. The board includes a set gypsum core disposed between first and second cover sheets (commonly face and back sheets, respectively). The set gypsum core is formed from a cementitious slurry comprising stucco, water, and optional ingredients as desired, including, for example, foaming agent, accelerator (e.g., heat resistant accelerator), retarder, dispersant, migrating starch, polyphosphate, etc. A dense layer can be provided that generally has a significantly greater density and significantly lesser thickness than that of the remainder of the board core. The face side of the board normally is facing out and is visible when installed to the structure, while the back side faces inward, toward support structures such as studs.

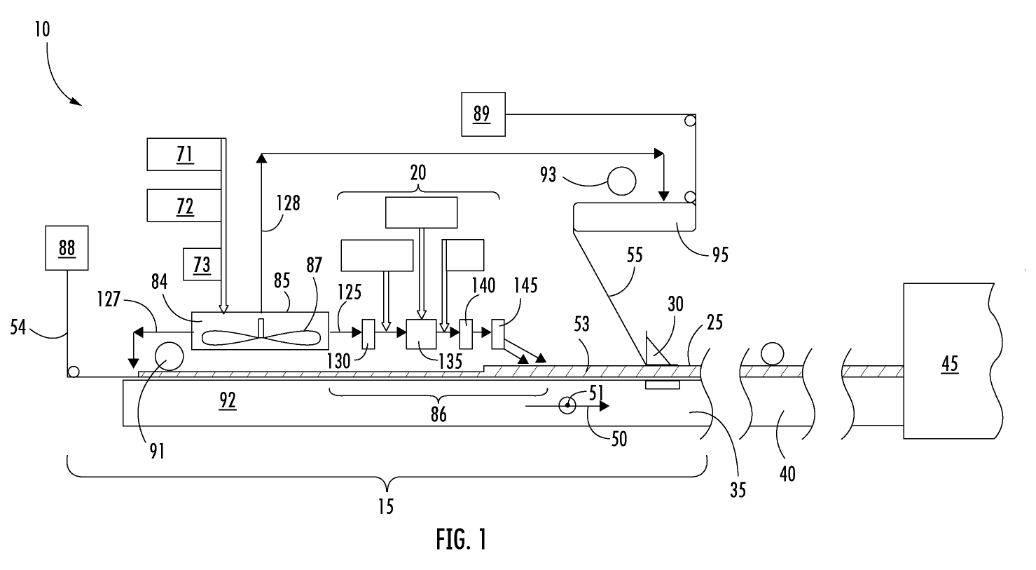

Turning now to the Figures, an embodiment of a system 10 for manufacturing a cementitious board 25 constructed according to principles of the present disclosure is shown schematically in FIG. 1. The illustrated system 10 includes a wet end system 15 with an embodiment of an in situ foam generation system 20 constructed according to principles of the present disclosure and a forming station 30; a conveyor 35; a cutting station 40; and a dryer 45 constructed according to principles of the present disclosure. The conveyor 35 is configured to convey the cementitious board 25 along a machine direction 50.

The cementitious board 25 has a cementitious core 53 interposed between a pair of cover sheets 54, 55. The cementitious core 53 is formed from an aqueous cementitious slurry. The cementitious board 25 has a pair of edges extending along the machine direction 50. The edges are disposed in lateral spaced relationship to each other along a cross-machine direction 51 which is perpendicular to the machine direction 50.

The wet end system 15 is configured to mix and assemble constituent materials together such that a continuous cementitious board 25 having a predetermined nominal thickness is fed from the forming station 30 along the conveyor 32 in the machine direction 50 toward the cutting station 40. The wet end system 15 can include any suitable equipment adapted to mix and/or assemble the constituent materials forming the cementitious board 25. In the illustrated embodiment, the wet end system 15 is configured as a gypsum wallboard wet end system.

The wet end system 15 includes a slurry mixer 84 in fluid communication with a slurry dispensing system 86 and with the in situ foam generation system 20. The slurry mixer 84 is adapted to agitate water 71 and a cementitious material 72 (such as, calcined gypsum, for example) to form aqueous cementitious slurry. Both the water 71 and the cementitious material 72 can be supplied to the mixer 84 via one or more inlets as is known in the art. In embodiments, any other suitable slurry additive, such as retarder 73 as is shown in FIG. 1, can be supplied to the mixer 84 as is known in the art of manufacturing cementitious products. In embodiments, retarder 73 is included in the aqueous cementitious slurry in order to facilitate the passage of the cementitious slurry through the slurry dispensing system 86 to aid the in situ generation of foam in the slurry as it passes therethrough.

In embodiments, the mixer 84 includes a housing 85 and an agitator 87 disposed within the housing. The agitator 87 is configured to agitate water 71 and a cementitious material 72 to form an aqueous cementitious slurry. In embodiments, the mixer 84 can comprise any suitable mixer, such as, for example, a pin mixer as is known in the art and commercially available from a variety of sources, including John Broeders Machine Co. Ltd. of Ontario, Canada, for example.

In use, water 71 and a cementitious material 72, such as calcined gypsum, for example, can be agitated in the mixer 84 to form aqueous cementitious slurry. In some embodiments, water 71 and calcined gypsum 72 can be continuously added to the mixer 84 in a water-to-calcined gypsum ratio from about 0.5 to about 1.3, and in other embodiments of about 0.9 or less.

In the illustrated embodiment, the slurry dispensing system 86 includes a main discharge conduit 125 and a pair of auxiliary discharge conduits 127, 128 in fluid communication with the slurry mixer 84 via, respectively, a main outlet and a pair of secondary outlets defined in the housing 85. The slurry dispensing system 86 is in fluid communication with the slurry mixer 84 and is configured to dispense a main flow of cementitious slurry from the slurry mixer 84 via the main discharge conduit 125 upon a forming table 92, which extends between the slurry dispensing system 86 and the forming station 30 and comprises a portion of the conveyor 35. Cementitious slurry can be discharged from the discharge conduit 125 of the slurry dispensing system 86 in an outlet flow direction substantially along the machine direction 50. Secondary flows of aqueous cementitious slurry can be dispensed respectively from the auxiliary discharge conduits 127, 128 for use as skim coat layers applied to the cover sheets 54, 55. In embodiments, the slurry dispensing system 86 can include any suitable discharge conduit, as is known in the art. The main discharge conduit 125 is in fluid communication with the mixer 84. The main discharge conduit 125 is configured to deliver a main flow of cementitious slurry from the mixer 84 downstream to a further manufacturing station (e.g., upon a moving web of cover sheet material in embodiments used to produce gypsum wallboard).

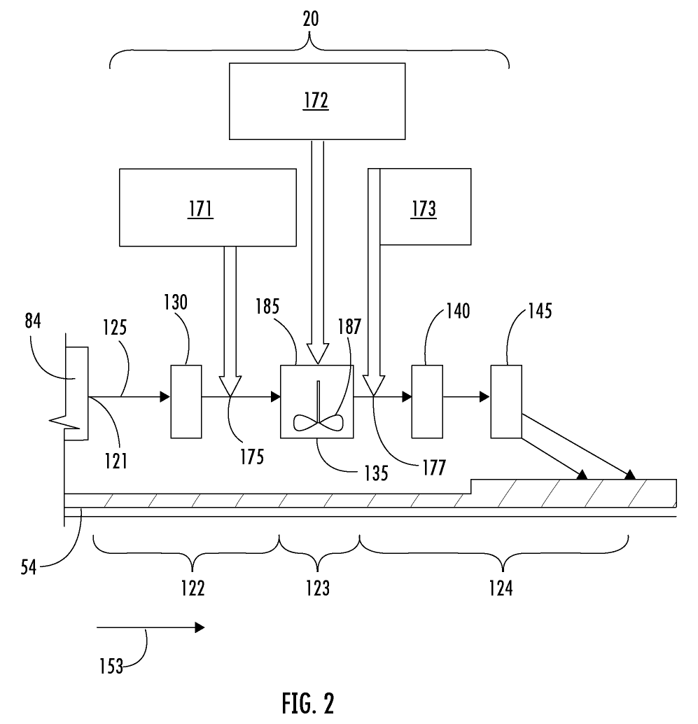

Referring to FIG. 2, the discharge conduit 125 is in fluid communication with the main outlet 121 of the mixer 84. The discharge conduit 125 defines a slurry passage. The discharge conduit 125 is connected to the mixer 84 such that the slurry passage is in fluid communication with the main outlet 121. In embodiments, the main discharge conduit 125 can comprise any suitable discharge conduit component as will be appreciated by one skilled in the art. The discharge conduit 125 can be made from any suitable material and can have different shapes. In embodiments, the discharge conduit 125 comprises a resiliently flexible conduit.

The illustrated main discharge conduit 125 includes a mixer portion 122, a foam portion 123, and a terminal portion 124. The mixer portion 122 is connected to the main outlet 121 of the mixer 84. The terminal portion 124 is downstream of the mixer portion 122 relative to a flow direction 153 of aqueous cementitious slurry from the mixer 84 through the discharge conduit 125. The foam portion 123 is interposed between the mixer portion 122 and the terminal portion 124.

The illustrated main discharge conduit 125 includes a slurry pump 130, a foam generation mixer 135 of the foam generation system 20, a flow-modifying element 140, and a slurry distributor 145. The slurry pump 130 forms part of the mixer portion 122 of the discharge conduit 125 disposed between the outlet 121 of the mixer 84 and the foam generation mixer 135. The foam generation mixer 135 forms the foam portion 123 of the discharge conduit 125. The flow-modifying element 140 and the slurry distributor form part of the terminal portion 124 of the discharge conduit 125 disposed downstream of the foam generation mixer 135.

In embodiments, the slurry pump 130 can be provided to help convey the aqueous cementitious slurry through the foam generation mixer 135 in the discharge conduit 125. In embodiments, the slurry pump 130 can comprise any suitable pump. For example, in embodiments, the slurry pump 130 comprises a peristaltic pump.

In the illustrated embodiment, the slurry pump 130 is disposed between the outlet 121 of the mixer 84 and the foam generation mixer 135. In other embodiments, suitable equipment can be provided downstream of the foam generation mixer 135 to help draw the aqueous cementitious through the foam generation mixer 135.

The in situ foam generation system 20 is suitable for use in embodiments of a system for manufacturing cementitious board following principles of the present disclosure. In embodiments, the in situ foam generation system 20 can be configured to generate foam in situ in the discharge conduit 125 downstream of the mixer 84 along the flow direction 153. In the illustrated embodiment, the in situ foam generation system 20 is arranged with the main discharge conduit 125. In other embodiments, an in situ foam generation system constructed according to principles of the present disclosure can be arranged with one or both of the auxiliary discharge conduits 127, 128.

The foam generation system 20 includes the foam generation mixer 135, a supply of foaming agent 171, and a supply of air 172. The foam generation mixer 135 is configured to generate foam by agitating the foaming agent and air together and to disperse the foam into the aqueous cementitious slurry passing therethrough. The foam generation mixer 135 comprises the foam portion 123 of the discharge conduit 125 disposed between the mixer portion 122 and the terminal portion 124.

The supply of foaming agent 171 is in fluid communication with the mixer portion 122 of the discharge conduit 125 at a soap junction 175 between the outlet 121 of the mixer 84 and the foam generation mixer 135. The slurry pump 130 is disposed between the outlet 121 of the mixer 84 and the soap junction 175.

In embodiments, the soap junction 175 of the supply of foaming agent 171 is disposed downstream of the slurry mixer 84 and is associated with the mixer portion 122 of the discharge conduit 125. In the illustrated embodiment, the foaming agent supply conduit is disposed downstream of the slurry mixer 84 and is disposed between the slurry pump 130 and the foam generation mixer 135. In some embodiments, the foaming agent supply conduit has a manifold-type arrangement for supplying foaming agent to a plurality of foaming agent injection ports defined within an injection ring or block comprising part of the mixing portion 122 of the discharge conduit 125, following principles described in U.S. Patent No. 6,874,930, for example.

In embodiments, any suitable foaming agent can be used. Preferably, the foam generation system 20 produces foam in a continuous manner in which a stream of the foaming agent is directed to the foam generation mixer 135 and is mixed with air and the aqueous cementitious slurry in the foam generation mixer 135 to produce a flow of foamed cementitious slurry. In embodiments, the foaming agent 171 comprises any suitable foaming agent/surfactant, such as an anionic, amphoteric or nonionic surfactant or a blend thereof, such as, e.g., an alkyl sulfate or an alkyl ether sulfate based surfactant blend. In embodiments, the foaming agent 171 comprises a foaming agent having a desired stability for the intended application. In embodiments, the foaming agent 171 comprises a blend of at least one stable foaming agent and one unstable foaming agent. In embodiments, the foaming agent 171 comprises a suitable commercially-available surfactant. Examples of such a suitable commercially-available surfactant includes, for example, a commercially-available surfactant for gypsum slurries from BASF Corp., such as, e.g., Vinapor® GYP 3110 and GYP 10 foaming agents; from Stepan Co., such as, e.g., Polystep B-25 M and Steol CS230 foaming agents; and from Geo Specialty Chemicals, Inc., such as, e.g., Hyonic 25 AS and Hyonic PFM-33 foaming agents.

In embodiments, a supply of retarder can be provide for introduction in the cementitious slurry at a point downstream of the mixer, such as, with the supply of foaming agent 171 or at a location in proximity to the soap junction 175. In embodiments, the junction of the supply of retarder is disposed downstream of the slurry mixer 84 and is associated with the mixer portion 122 of the discharge conduit 125. In embodiments, the amount of retarder introduced at this downstream junction is adjusted to help the passage of the cementitious slurry through the foam generator 185. The extra retarder is preferably added downstream of the slurry mixer 84 so as to allow the skim coat/hard edge slurry stream(s) discharged from the slurry mixer 84 to have a lower concentration of retarder than is present in the core stream passing through the main discharge conduit 125.

The supply of air 172 is in fluid communication with the foam generation mixer 135. In embodiments, the supply of air 172 is pressurized such that the air can be injected into the foam generation mixer 135 and dispersed with in the flow of aqueous cementitious slurry entering the foam generation mixer from the mixer portion 122 of the discharge conduit 125. In embodiments, the air line between the air compressor and the foam generation mixer 135 includes at least one filter to remove particulates from the supply of air 172. In embodiments, the amount of air 172 fed into the foam generation mixer 135 can be regulated to achieve a desired amount of air voids in the finished cementitious board 25, such as, at least 10 cubic feet of air voids per thousand square feet of board (cu. ft./msf), e.g., and at least 14 cu. ft./msf in other embodiments.

In embodiments, the foam generation mixer 135 can comprise any suitable foam generator as is known to those skilled in the art. In embodiments, the foam generation mixer 135 is configured to impart more shear upon the aqueous cementitious slurry than it receives in the slurry mixer 84. Any suitable technique for determining relative shear (or a proxy for shear, including, e.g., the amount of relative power used by mixers 84, 135, e.g.) in the mixers 84, 135 can be used.

In embodiments, the foam generation mixer 135 includes a housing 185 within which is disposed an agitator 187. In embodiments, the foam generation mixer 135 comprises a high-shear mixer which includes an agitator 187 adapted to rotate at with a number of revolutions per minute (rpm) that is greater that the number of rpm at which the agitator 87 of the main slurry mixer 84 rotates. In embodiments, the agitator 187 of the foam generation mixer 135 rotates at a number of rpm that is at least three times greater than the number of rpm at which the agitator 87 of the slurry mixer 84 rotates. In embodiments, the agitator 187 of the foam generation mixer 135 rotates at a number of rpm that is at least five times greater than the number of rpm at which the agitator 87 of the slurry mixer 84 rotates. In embodiments, the agitator 187 of the foam generation mixer 135 rotates at about 3000 rpm, and the agitator 87 of the slurry mixer 84 rotates at about 450 rpm.

In embodiments, the housing 185 of the foam generation mixer 135 defines a slurry passageway and an air passageway. The slurry passageway comprises a portion of the discharge conduit 125 such that the slurry passageway is in fluid communication with the outlet 121 of the mixer 84. The air passageway of the foam generation mixer 135 is in fluid communication with the slurry passageway and with the supply of air 172 such that the supply of air 172 is in fluid communication with the slurry passageway via the air passageway.

In embodiments, the flow-modifying element 140 is a part of the main discharge conduit 125 and is adapted to modify a flow of the aqueous cementitious slurry from the mixer 84 through the main discharge conduit 125. In embodiments, the flow-modifying element(s) 140 can be used to control an operating characteristic of the main flow of aqueous cementitious slurry. In embodiments, one or more flow-modifying elements 140 can be associated with the main discharge conduit 125 and adapted to control a main flow of slurry discharged from the slurry mixer 84.

In embodiments, the flow-modifying element 140 is associated with one of the mixer portion 122 and the terminal portion 124 of the discharge conduit 125. In the illustrated embodiment, the flow-modifying element 140 is associated with the terminal portion 124 of the discharge conduit 125 and is located downstream of the foam generation mixer 135. In embodiments, the flow-modifying element 140 is disposed downstream, relative to the flow direction 153 of the flow of cementitious slurry from the mixer 84 through the main discharge conduit 125, of the soap junction 175 at which the supply of foaming agent 171 is inserted into the discharge conduit 125.

Examples of a suitable flow-modifying element 140 include volume restrictors, pressure reducers, constrictor valves, canisters etc., including those described in U.S. Patent Nos. 6,494,609; 6,874,930; 7,007,914; and 7,296,919, for example. In embodiments, the flow-modifying element 140 comprises a constrictor valve mounted to the discharge conduit 125 which comprises a resiliently flexible conduit, and the constrictor valve 140 is configured to selectively constrict the resiliently flexible conduit.

In embodiments, the slurry distributor 145 can be any suitable terminal portion of a conventional discharge conduit, such as a length of conduit in the form of a flexible hose or a component commonly referred to as a “boot.” In embodiments, the boot can be in the form of a multi-leg discharge boot.

In other embodiments, the slurry distributor 145 can be similar to those shown and described in U.S. Patent Application Nos. 2012/0168527; 2012/0170403; 2013/0098268; 2013/0099027; 2013/0099418; 2013/0100759; 2013/0216717; 2013/0233880; and 2013/0308411. In some of such embodiments, the main discharge conduit 125 can include suitable components for splitting, downstream of the foam generation mixer 135, e.g., a main flow of cementitious slurry into two flows which are re-combined in the slurry distributor 145.

In embodiments an additive injection system suitable for introducing at least one additive can be associated with the main discharge conduit 125 in fluid communication with the slurry mixer 84. An additive(s) supply can be placed in fluid communication with the additive injection system to inject at least one additive into the aqueous cementitious slurry passing through the discharge conduit 125 with which the additive injection system is associated.

In the illustrated embodiment, a supply of fluid accelerator 173 is in fluid communication with the terminal portion 124 of discharge conduit 125 at an accelerator junction 177 downstream of the foam generation mixer 135. In embodiments, a suitable amount of accelerator can be added to the foamed cementitious slurry to promote the gypsum hydration process. In other embodiments, the supply of fluid accelerator 173 can be omitted. In other embodiments, one or more other additives can be added to the foamed cementitious slurry downstream of the foam generation mixer 135, either with or without fluid accelerator.

Referring to FIG. 1, a first roll 88 of cover sheet material is configured to be selectively dispensed such that the first cover sheet 54 is dispensed from the first roll 88 upstream of the slurry dispensing system 86 upon the forming table 92 extending between the slurry mixer 84 and the dispensing system 86 and the forming station 30. A second roll 89 of cover sheet material is configured to be selectively dispensed such that the second cover sheet 55 is dispensed from the second roll 89 upon the forming table at a position between the slurry dispensing system 86 and the forming station 30 over the first cover sheet 54 and the slurry 53 dispensed from the slurry dispensing system 86. Gypsum board products are typically formed “face down” such that the first cover sheet 54 dispensed from the first roll 88 traveling over the forming table serves as the “face” cover sheet 54 of the finished cementitious board 25.

As one of ordinary skill in the art will appreciate, one or both of the webs 54, 55 of cover sheet material can be pre-treated with a very thin relatively denser layer of gypsum slurry (relative to the gypsum slurry comprising the core), often referred to as a skim coat in the art, and/or hard edges, if desired. To that end, the first auxiliary discharge conduit 127 is adapted to deposit a stream of dense aqueous calcined gypsum slurry (i.e., a “face skim coat/hard edge stream”) that is relatively denser than the main flow of aqueous calcined gypsum slurry discharged from the main discharge conduit 125.

The first auxiliary discharge conduit 127 can include an additive injection system suitable for introducing at least one additive into the face skim coat/hard edge stream. An additive(s) supply can be placed in fluid communication with the additive injection system of the first auxiliary discharge conduit 127 to inject at least one additive into the face skim coat/hard edge stream. In embodiments, the additive(s) supply comprises fiber.

The exemplary embodiment of a wet end system 15 of a gypsum wallboard manufacturing line includes a hard edge/face skim coat roller 91 disposed upstream of the slurry distributor 145 of the main discharge conduit 125 and supported over the forming table 92 such that a first moving web 54 of cover sheet material is disposed therebetween, and a back skim coat roller 93 disposed over a support element 95 such that a second moving web 55 of cover sheet material is disposed therebetween. The skim coat rollers 91, 93, the forming table 92, and the support element 95 can all comprise conventional equipment suitable for their respective intended purposes as is known in the art.

In embodiments, the hard edge/face skim coat roller 91 is disposed upstream of the slurry dispensing system 86 and supported over the forming table 92 such that the first cover sheet 54 being dispensed from the first roll 88 is disposed therebetween. The first auxiliary conduit 127 can deposit the face skim coat/hard edge stream upon the first cover sheet 54 being dispensed from the first roll 88 upstream of the skim coat roller 91 which is adapted to apply a skim coat layer to the moving first cover sheet 54 and to define hard edges at the periphery of the moving first cover sheet 54 by virtue of the width of the roller 91 along the cross-machine direction 51 being less than the width of the moving first cover sheet 54 as is known in the art. Hard edges can be formed from the same dense slurry that forms the thin dense layer by directing portions of the dense slurry around the ends of the roller 91 used to apply the dense layer to the first cover sheet 54.

In embodiments, the back skim coat roller 93 is disposed over the support element 95 such that the second cover sheet 55 being dispensed from the second roll 89 is disposed therebetween. The mixer 84 can also include the second auxiliary conduit 128 adapted to deposit a stream of dense aqueous calcined gypsum slurry that is relatively denser than the main flow of aqueous calcined gypsum slurry delivered to the discharge conduit 86 (i.e., a “back skim coat stream”). The second auxiliary conduit 128 can deposit the back skim coat stream upon the moving second cover sheet 55 upstream (in the direction of movement of the second cover sheet 55) of the back skim coat roller 93 that is adapted to apply a skim coat layer to the second cover sheet 55 being dispensed from the second roll 89 as is known in the art.

In embodiments, the second auxiliary discharge conduit 128 can include an additive injection system suitable for introducing at least one additive into the back skim coat stream. An additive(s) supply can be placed in fluid communication with the additive injection system of the second auxiliary discharge conduit 128 to inject at least one additive into the back skim coat stream. In embodiments, the additive(s) supply comprises fiber.

In embodiments, an in situ foam generation system constructed according to principles of the present disclosure can be associated with one or both of the auxiliary delivery conduits 127, 128 to produce skim coat streams having voids therein. As will be appreciated by those skilled in the art, the means for introducing foam into the various slurry streams from the mixer 84, including its relative location in the system, can be varied and/or optimized to provide a uniform dispersion of foam in the cementitious slurry to produce board that is fit for its intended purpose.

In yet other embodiments, a conventional foam injection system can be arranged with at least one of the mixer 84 and the auxiliary delivery conduits 127, 128 to produce skim coat streams having voids therein. The foam injection system can include a foam source (e.g., such as a foam generation system configured as known in the art) and a foam supply conduit. The aqueous foam supply conduit can be in fluid communication with at least one of the slurry mixer 84 and the auxiliary delivery conduits 127, 128. An aqueous foam from a source can be added to the constituent materials through the foam supply conduit at any suitable location downstream of the mixer 84 and/or in the mixer 84 itself to form a foamed skim coat stream(s). In such arrangements, the amount of air voids introduced into the skim coat stream(s) can be less than the amount of air voids introduced into the main foamed cementitious slurry produced by the in situ foam generation system 20 associated with the main discharge conduit 125.

In other embodiments, separate auxiliary conduits can be connected to the mixer 84 to deliver one or more separate edge streams to the moving cover sheet. Other suitable equipment (such as auxiliary mixers) can be provided in the auxiliary conduits to help make the slurry therein denser, such as by mechanically breaking up foam in the slurry and/or by chemically breaking down the foam through use of a suitable de-foaming agent.

The forming station 30 is configured to form the cementitious board 25 such that the cementitious board 25 is within a predetermined thickness range. The forming station 30 can comprise any equipment suitable for its intended purpose as is known in the art.

The wet end system 15 can be equipped with other conventional equipment as is known in the art. For example, board manufacturing techniques described in, for example, U.S. Patent 7,364,676 and U.S. Patent Application Publication No. US2010/0247937 can be incorporated into the wet end system 15.

The conveyor 32 is configured to convey the cementitious board 25 along the machine direction 50 away from the forming station 30 toward the dryer 45. In embodiments, the conveyor 32 is configured such that it has a length, measured along the machine direction 50, sufficient to allow the cementitious slurry constituting the cementitious core 53 to adequately set before reaching the cutting station 40 such that the cementitious board 25 can be cut cleanly.

The cutting station 40 is disposed downstream of the forming station 30 along the machine direction 50. The cutting station 40 is arranged with respect to the conveyor 32 such that the conveyor 32 carries the cementitious board 25 past the cutting station 40. The cutting station 40 can include a knife configured to periodically cut the cementitious board 25 along the cross-machine direction 51 to define a series of board segments as the cementitious board 25 moves along the machine direction 50 past the cutting station 40. In embodiments, the knife can be a rotary knife as is generally known to those skilled in the art.

In embodiments, the dryer 45 can be associated with the conveyor 32 to receive cementitious board 25 therefrom in a continuous manner as is known in the art. The dryer 45 can be configured to remove excess water remaining in the cementitious board 25 after the cementitious slurry has undergone a setting process, which is an exothermic reaction that generates heat.

An in situ foam generation system 20 in accordance with principles of the present disclosure can advantageously be configured as a retrofit in an existing wallboard manufacturing system. The foam generation system 20 can be used with components of a conventional wallboard manufacturing line.

In embodiments, the system 10 for manufacturing a cementitious board 25 can include other components and stations. For example, in embodiments, the system 10 can include a transfer system with a board inverter downstream of the cutting station 40 and upstream of the dryer 45 and a bundler and taping station downstream of the dryer 45

In use, the gypsum board 25 can be prepared in any suitable manner. For example, in embodiments, the first cover sheet 54 is dispensed from the first roll 88 and moves along the machine direction 50. Water and calcined gypsum can be mixed in the mixer 84 to form an aqueous calcined gypsum slurry. In some embodiments, the water and calcined gypsum can be continuously added to the mixer in a water-to-calcined gypsum ratio from 0.5 to 1.3, and in other embodiments of 0.75 or less.

A main flow of aqueous calcined gypsum slurry is discharged from the mixer 84 into the main discharge conduit 125. The slurry pump 130 can be operated to help convey aqueous cementitious slurry from the mixer 84 to and through the foam generation mixer 135.

Foam can be generated in situ in the main flow of aqueous calcined gypsum slurry passing through foam generation mixer 135 via the in situ foam generation system 20 to form a flow of foamed calcined gypsum slurry. The main flow of foamed calcined gypsum slurry can be acted upon by one or more flow-modifying elements 140 and discharged from the slurry distributor 145 of the main discharge conduit 125 upon the first moving web 54.

The cementitious slurry is discharged from the discharge conduit 86 upon the moving first cover sheet 54. The face skim coat/hard edge stream can be deposited from the mixer 84 at a point upstream of where the cementitious slurry is discharged from the main discharge conduit 125 upon the moving first cover sheet 54 relative to the direction of movement of the first cover sheet 54 in the machine direction 50. A back skim coat stream (a layer of denser slurry relative to the main flow of cementitious slurry being discharged from the discharge conduit 86) can be applied to the second cover sheet 55 being dispensed from the second roll 89. The back skim coat stream can be deposited from the mixer 84 at a point upstream of the back skim coat roller 93 relative to the direction of movement of the moving second cover sheet 55.

In embodiments, aqueous foam or other agents can be added to the slurry comprising the face skim coat and/or back skim coat to reduce its density, but at a density that is greater than the foamed slurry dispensed from the main discharge conduit 125. In embodiments, fiber, starch, aqueous foam, or other additives can be added to the slurry comprising the face skim coat and/or back skim coat via additive injection systems respectively associated with the first and second auxiliary discharge conduits 127, 128.

The moving second cover sheet 55 can be placed upon the slurry deposited upon the advancing first cover sheet 54 to form a sandwiched wallboard preform that is fed to the forming station 30 to shape the preform to a desired thickness.

In embodiments, the main flow of cementitious slurry has a first volumetric flow rate, the face skim coat/hard edge stream has a second volumetric flow rate, and the back skim coat stream has a third volumetric flow rate. In embodiments, the first volumetric flow rate is greater than the second volumetric flow rate, and the first volumetric flow rate is greater than the second volumetric flow rate. In embodiments, the second volumetric flow rate is greater than the third volumetric flow rate.

Board 25 can be made with different dimensions, depending on, e.g., product type and market. The board 25 can have any suitable width (e.g., 48 inches to 54 inches), length (e.g., 96 inches to 192 inches), and thickness (e.g., ¼ inch, ³/₈ inch, ½ inch, ⁵/₈ inch, ¾ inch, 1 inch, etc.). The board thickness can vary depending on the location the board is used and the type of application for the product (e.g., regular board at one-half inch or fire-resistant board at ⁵/₈ inch, i.e., 0.625 inch). Dimensions in different markets may vary slightly as is well understood in the art.

During the manufacturing process, tests can be used to determine the thickness, density, and/or hardness of the core and dense layer(s). During the manufacturing process the densities of the core and dense layers can be monitored by measuring the wet densities as follows. Slurry is poured into a cup with a known volume and the weight is recorded. Periodically, samples of both the dense and core layer slurries are poured into molds (cubes or discs) and both the wet and dry densities are estimated by measuring both the weights and dimensions before and after drying.

The core and dense slurry formulations can be made with any suitable water/stucco ratio, e.g., 0.4 to 1.5. For example, in some embodiments, the water/stucco ratio can be from 0.4 to 1.2, 0.4 to 1.1, 0.4 to 1, 0.4 to 0.9, 0.4 to 0.85, 0.45 to 0.85, 0.55 to 0.85, 0.55 to 0.8, 0.6 to 0.9, 0.6 to 0.85, 0.6 to 0.8, etc.

In some embodiments, the foaming agent comprises a major weight portion of unstable component, and a minor weight portion of stable component (e.g., where unstable and blend of stable/unstable are combined). The weight ratio of unstable component to stable component is effective to form an air void distribution within the set gypsum core. See, e.g., U.S. Patent Nos. 5,643,510; 6,342,284; and 6,632,550. It has been found that suitable void distribution and wall thickness can be effective to enhance strength, especially in lower density board (e.g., 35 pcf or less). See, e.g., U.S. Patent Application Publication Nos. US2007/0048490 and US2008/0090068. Evaporative water voids, generally having voids of about 5 µm or less in diameter, also contribute to the total void distribution along with the aforementioned air (foam) voids.

Additives such as accelerator (e.g., wet gypsum accelerator, heat resistant accelerator, and climate stabilized accelerator) and retarder are well known and can be included in the core slurry, if desired. See, e.g., U.S. Patent Nos. 3,573,947 and 6,409,825. For example, the core slurry can optionally include at least one dispersant to enhance fluidity in some embodiments. Like other ingredients, the dispersants may be included in a dry form with other dry ingredients and/or in a liquid form with other liquid ingredients in the core slurry. Examples of dispersants include naphthalenesulfonates, such as polynaphthalenesulfonic acid and its salts (polynaphthalenesulfonates) and derivatives, which are condensation products of naphthalenesulfonic acids and formaldehyde; as well as polycarboxylate dispersants, such as polycarboxylic ethers, for example, PCE211, PCE111, 1641, 1641F, or PCE 2641-Type Dispersants, e.g., MELFLUX 2641F, MELFLUX 2651F, MELFLUX 1641F, MELFLUX 2500L dispersants (BASF), and COATEX Ethacryl M, available from Coatex, Inc.; and/or lignosulfonates or sulfonated lignin.

Suitable additives for fire-rated and/or water resistant product can also optionally be included in the core slurry, including e.g., siloxanes (water resistance); fiber; heat sink additives such as aluminum trihydrite (ATH), magnesium hydroxide or the like; and/or high expansion particles (e.g., expandable to about 300% or more of original volume when heated for about one hour at 1560°F). See, e.g., U.S. Patent No. 8,323,785, filed as U.S. Patent Application No. 13/400,010 on February 17, 2012, for a description of these and other ingredients. In some embodiments, high expansion vermiculite is included, although other fire resistant materials can be included.

The cover sheets can be formed of any suitable material and basis weight. For example, some embodiments of the disclosure allow for good board strength even with the use of lower basis weight cover sheets such as, for example, less than 45 lbs./MSF (e.g., 33 lbs./MSF to 45 lbs./MSF) even for lower weight board (e.g., having a density of 35 pcf or below). However, if desired, in some embodiments, heavier basis weights can be used, e.g., to further enhance nail pull resistance or to enhance handling, e.g., to facilitate desirable “feel” characteristics for end-users. In some embodiments, to enhance strength (e.g., nail pull strength), especially for lower density board, one or both of the cover sheets can be formed from paper and have a basis weight of, for example, at least 45 lbs./MSF (e.g., from 45 lbs./MSF to 65 lbs./MSF, 45 lbs./MSF to 60 lbs./MSF, 45 lbs./MSF to 55 lbs./MSF, 50 lbs./MSF to 65 lbs./MSF, 50 lbs./MSF to 60 lbs./MSF, etc.). If desired, in some embodiments, one cover sheet (e.g., the “face” paper side when installed) can have aforementioned greater basis weight, e.g., to enhance nail pull resistance and handling, while the other cover sheet (e.g., the “back” sheet when the board is installed) can have somewhat lower weight basis if desired (e.g., weight basis of less than 45 lbs./MSF, e.g., from 33 lbs./MSF to 45 lbs./MSF (e.g., 33 lbs./MSF to 40 lbs./MSF).

A method of manufacturing a cementitious board following principles of the present disclosure can be practiced using any embodiment of a cementitious board manufacturing system constructed according to principles discussed herein. In embodiments of a method of manufacturing a cementitious board following principles of the present disclosure, a foam generation system constructed according to principles of the present disclosure is used to generate foam in situ in a discharge conduit of a mixer in an on-line manner during the continuous manufacture of the cementitious board. In embodiments, a method of manufacturing a cementitious board following principles of the present disclosure can be practiced using any embodiment of an in situ foam generation system constructed according to principles discussed herein.

In embodiments following principles of the present disclosure, a method of making a cementitious board includes discharging a flow of aqueous cementitious slurry from a mixer into a discharge conduit. A supply of foaming agent is introduced into the discharge conduit at a soap junction to disperse the supply of foaming agent into the flow of aqueous cementitious slurry. At a point downstream of the soap junction relative to a flow direction of the flow of aqueous cementitious slurry from the mixer, the flow of aqueous cementitious slurry is mixed with a supply of air to produce a flow of foamed cementitious slurry. The flow of foamed cementitious slurry is discharged from the discharge conduit onto a web of cover sheet material moving along a machine direction.

In embodiments of a method of making a cementitious board following principles of the present disclosure, the method includes agitating ingredients of at least water and a cementitious material in the mixer to form the flow of aqueous cementitious slurry. In embodiments, the ingredients comprise retarder. In embodiments, the cementitious material comprises stucco, and the cementitious board comprises gypsum wallboard.

In embodiments, the step of agitating ingredients to form the flow of aqueous cementitious slurry comprises rotating a first agitator in the mixer at a first number of revolutions per minute, and mixing the flow of aqueous cementitious slurry with a supply of air to produce the flow of foamed cementitious slurry comprises rotating a second agitator in a foam generator at a second number of revolutions per minute. In embodiments, the agitator of the foam generator rotates at a number of revolutions per minute that is greater than the number of revolutions per minute at which the agitator of the mixer rotates. In at least some embodiments, the agitator of the foam generator rotates at a number of revolutions per minute that is at least three times greater than the number of revolutions per minute at which the agitator of the mixer rotates, and is at least six times greater in yet other embodiments.

In embodiments, the flow of foamed aqueous cementitious slurry comprises a main flow of foamed aqueous cementitious slurry, and the discharge conduit comprises a main discharge conduit. In at least some of such embodiments, the method includes discharging a secondary flow of aqueous cementitious slurry from the mixer into a secondary discharge conduit. In at least some of such embodiments, the main flow of foamed cementitious slurry has a first volumetric flow rate, and the secondary flow of cementitious slurry has a second volumetric flow rate which is less than the first volumetric flow rate.

In at least some embodiments, the method includes discharging the secondary flow of cementitious slurry onto the web of cover sheet material moving along the machine direction. The secondary flow of cementitious slurry is formed into a skim coat layer applied against the web of cover sheet material moving along the machine direction at a point upstream of the main flow of foamed cementitious slurry discharging onto the web of cover sheet material such that the skim coat layer is interposed between the web of cover sheet material and the main flow of foamed cementitious slurry.

In embodiments, discharging the flow of foamed cementitious slurry onto a web of cover sheet material moving along a machine direction comprises discharging the flow of foamed cementitious slurry from a boot. In at least some of such embodiments, the boot comprises a multi-leg discharge boot.

In at least some embodiments, the method includes modifying the flow of the aqueous cementitious slurry through the discharge conduit. In at least some of such embodiments, discharging a flow of aqueous cementitious slurry from a mixer into a discharge conduit comprises discharging the flow of aqueous cementitious slurry from the mixer into a slurry passage defined within a resiliently flexible conduit, and modifying the flow of the aqueous cementitious slurry through the discharge conduit comprises constricting a portion of the resiliently flexible conduit using a constrictor valve to change at least a part of the shape of the slurry passage within the portion of the conduit.

In at least some embodiments, the method includes pumping the flow of aqueous cementitious slurry in the discharge conduit to the soap junction. In at least some embodiments, the method includes introducing a supply of fluid accelerator into the discharge conduit, at an accelerator junction downstream of the soap junction, to disperse the supply of fluid accelerator into the flow of foamed cementitious slurry.

All references cited herein are hereby incorporated by reference to the same extent as if each reference were individually and specifically indicated to be incorporated by reference and were set forth in its entirety herein.

The use of the terms “a” and “an” and “the” and “at least one” and similar referents in the context of describing the invention (especially in the context of the following claims) are to be construed to cover both the singular and the plural, unless otherwise indicated herein or clearly contradicted by context. Neither gypsum nor water in a cementitious slurry is considered to be an “additive.” When amounts are compared between the core and dense layer slurries, it will be understood that it is in relation to a relative comparison, i.e., concentration. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A system for manufacturing a cementitious board, the system comprising:
a mixer, the mixer including a housing and an agitator disposed within the housing, the housing having an outlet, the agitator being configured to agitate water and cementitious material to form an aqueous cementitious slurry;
a discharge conduit, the discharge conduit is in fluid communication with the outlet of the mixer, the discharge conduit including a mixer portion and a terminal portion, the mixer portion being connected to the outlet of the mixer, and the terminal portion being downstream of the mixer portion relative to a flow direction of aqueous cementitious slurry from the mixer through the discharge conduit;
a foam generation system, the foam generation system including a foam generation mixer, a supply of foaming agent, and a supply of air, the foam generation mixer comprising a foam portion of the discharge conduit disposed between the mixer portion and the terminal portion, the supply of foaming agent being in fluid communication with the mixer portion of discharge conduit at a soap junction between the outlet of the mixer and the foam generation mixer, the supply of air being in fluid communication with the foam generation mixer.

2. The system of claim 1, further comprising:
a slurry pump, the slurry pump forming part of the mixer portion of the discharge conduit disposed between the outlet of the mixer and the foam generation mixer.

3. The system of claim 2, wherein the slurry pump is disposed between the outlet of the mixer and the soap junction.

4. The system of claim 2, wherein the slurry pump comprises a peristaltic pump.

5. The system of claim 1, wherein the housing and the agitator of the mixer comprises a first housing and a first agitator, and the foam generation mixer includes a second housing and a second agitator disposed within the second housing, wherein the first agitator is adapted to rotate at a first number of revolutions per minute, and the second agitator is adapted to rotate at a second number of revolutions per minute, the second number being greater than the first number.

6. The system of claim 5, wherein the second number is at least three times greater than the first number.

7. The system of claim 5, wherein the second housing defines a slurry passageway and an air passageway, the slurry passageway comprising a portion of the discharge conduit such that the slurry passageway is in fluid communication with the outlet of the mixer, the air passageway in fluid communication with the slurry passageway and with the supply of air such that the supply of air is in fluid communication with the slurry passageway via the air passageway.

8. The system of claim 1, wherein the discharge conduit comprises a resiliently flexible conduit.

9. The system of claim 8, further comprising:
a constrictor valve, the constrictor valve mounted to the resiliently flexible conduit and configured to selectively constrict the resiliently flexible conduit.

10. The system of claim 8, wherein the terminal portion of the discharge conduit includes a boot.

11. The system of claim 1, further comprising:
a supply of fluid accelerator, the supply of fluid accelerator in fluid communication with the terminal portion of discharge conduit at an accelerator junction downstream of the foam generation mixer.

12. The system of claim 1, wherein the outlet of the mixer comprises a first outlet and the discharge conduit comprises a main discharge conduit, and wherein the housing includes a second outlet, the system further comprising:
a secondary discharge conduit, the secondary discharge conduit is in fluid communication with the second outlet of the mixer; and
a flow-modifying element associated with one of the mixer portion and the terminal portion of the discharge conduit and adapted to modify a flow of the aqueous cementitious slurry through the discharge conduit.

13. A method of preparing a cementitious product comprising:
agitating ingredients of at least water and a cementitious material in a mixer to form a flow of aqueous cementitious slurry;
discharging the flow of aqueous cementitious slurry from the mixer into a discharge conduit;
introducing a supply of foaming agent into the discharge conduit, at a soap junction, to disperse the supply of foaming agent into the flow of aqueous cementitious slurry;
mixing, at a point downstream of the soap junction relative to a flow direction of the flow of aqueous cementitious slurry from the mixer, the flow of aqueous cementitious slurry with a supply of air to produce a flow of foamed cementitious slurry;
discharging the flow of foamed cementitious slurry from the discharge conduit onto a web of cover sheet material moving along a machine direction.

14. The method of claim 13, wherein the ingredients comprise retarder.

15. The method of claim 13, wherein agitating ingredients to form the flow of aqueous cementitious slurry comprises rotating a first agitator in the mixer at a first number of revolutions per minute, and mixing the flow of aqueous cementitious slurry with a supply of air to produce the flow of foamed cementitious slurry comprises rotating a second agitator in a foam generator at a second number of revolutions per minute, the second number being greater than the first number.

16. The method of claim 15, wherein the second number is at least three times greater than the first number.

17. The method of claim 13, wherein the flow of foamed aqueous cementitious slurry comprises a main flow of foamed aqueous cementitious slurry, and the discharge conduit comprises a main discharge conduit, and the method further comprising:
discharging a secondary flow of aqueous cementitious slurry from the mixer into a secondary discharge conduit;
wherein the main flow of foamed cementitious slurry has a first volumetric flow rate, and the secondary flow of cementitious slurry has a second volumetric flow rate, the first volumetric flow rate being greater than the second volumetric flow rate.

18. The method of claim 17, further comprising:
discharging the secondary flow of cementitious slurry onto the web of cover sheet material moving along the machine direction;
forming the secondary flow of cementitious slurry into a skim coat layer applied against the web of cover sheet material moving along the machine direction at a point upstream of the main flow of foamed cementitious slurry discharging onto the web of cover sheet material such that the skim coat layer is interposed between the web of cover sheet material and the main flow of foamed cementitious slurry.

19. The method of claim 13, further comprising:
pumping the flow of aqueous cementitious slurry in the discharge conduit to the soap junction.

20. The method of claim 13, further comprising:
introducing a supply of fluid accelerator into the discharge conduit, at an accelerator junction downstream of the soap junction, to disperse the supply of fluid accelerator into the flow of foamed cementitious slurry.
